(19) United States
(12) Patent Application Publication
(10) Pub. No.: US 2007/0211293 A1
(43) Pub. Date: Sep. 13, 2007

(54) Document management system, method and program therefor

(75) Inventor: Noriyuki Komamura, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/373,765

(22) Filed: Mar. 10, 2006

(51) Int. Cl. G06K 15/00

(52) U.S. Cl. 358/1.18

(57) ABSTRACT

To provide a technology that can contribute to improvements in convenience in document management by enabling management in units of component elements of contents of documents to be managed. The system is provided with: an extraction unit that extracts component elements forming contents of a document to be managed from the document; an association unit that associates predetermined metadata characterizing the component elements with the component elements extracted in the extraction unit; and a registration unit that registers information on the component elements and metadata associated in the association unit.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to a document management system for performing predetermined management of documents to be managed, and a method and a program therefor.

2. Description of the Related Art

Generally, contents of one document are normally formed by combining a plurality of some kinds component elements such as title parts, main body parts and chart parts.

Accordingly, all of the main body parts and chart parts contained as contents of the document are not always information that should be disclosed, but sometimes they are unwanted information for someone, or they contain information undesirable for particular people to see.

Conventionally, in response to this, measures to perform the disclosure restriction have been taken by creating documents in advance for different variations according to use applications and purposes and setting access rights to storage locations of the documents.

This is management in units of documents, however, if the information of documents can be managed in units of component elements of the documents, it would be preferable because the display restriction of document contents can be performed at the levels of component elements, and reuse of component elements can be performed.

Although it is desirable that component elements may be registered in databases or the like in advance and managed on the assumption that the documents are thus used, regarding electronic documents, paper documents, etc. that have not been created (or are not to be created) on the assumption, such use restriction and management in units of component elements (objects) of documents have been impossible.

As a conventional technology related thereto, a technology (JP-A-2002-41498) of dividing contents information of documents into objects of component elements such as chart parts and title parts by layout analysis, and storing component elements and component information separately, or distributing and storing component elements has been proposed.

However, the purpose of the conventional technology is, in the case where part of elements that form a document is not available, to enable prevention of complete loss of a document file by distributing and managing the objects (component elements) divided by layout analysis, or, in the case where it is necessary to hold a plurality of the same document, to suppress increase in file size by copying and holding only the layout information (component information) of the documents. That is, the technology has not been proposed with respect to use restriction of component elements of document contents, or is not for managing the respective component elements according to some rules (e.g., according to the kinds thereof).

The invention has been achieved in order to solve the above described problems, and a purpose thereof is to provide a technology that can contribute to improvements in convenience in document management by enabling management in units of component elements of contents of documents to be managed.

### DESCRIPTION OF THE DRAWINGS

FIG. 1 is a network configuration diagram for explanation of an application example of a document management system according to the embodiment.

FIG. 2 is a functional block diagram for explanation of document management system S according to the embodiment.

FIG. 3 is a flowchart for explanation of details of a flow of processing in the document management system S.

FIG. 4 shows examples of document information structure.

FIG. 5 shows examples of operation history information structure.

FIG. 6 shows an example of application screen.

FIG. 7 is a flowchart for explanation of details of a flow of the processing in the document management system S.

FIG. 8 shows examples of component element information structure.

FIG. 9 is a flowchart for explanation of details of a flow of the processing in the document management system S.

FIG. 10 is a diagram for explanation of the case where metadata is embedded within a document file.

FIG. 11 shows an example of document display application.

FIG. 12 is a flowchart for explanation of details of a flow of the processing in the document management system S.

FIG. 13 is a flowchart for explanation of details of a flow of the processing in the document management system S.

FIG. 14 is a flowchart for explanation of details of a flow of the processing in the document management system S.

FIG. 15 shows examples of determination rules structure.

FIG. 16 shows an example of the structure of user security settings.

FIG. 17 shows examples of template information structure.

FIG. 18 shows examples of constructed document structure.

FIG. 19 is a flowchart for explanation of details of a flow of the processing in the document management system S.

FIG. 20 is a flowchart for explanation of details of a flow of the processing in the document management system S.

### DETAILED DESCRIPTION OF THE INVENTION

Hereinafter, an embodiment of the invention will be described by referring to the drawings.

Throughout this description, the embodiments and examples shown should be considered as exemplars, rather than limitations on the apparatus, methods and programs of the present invention.

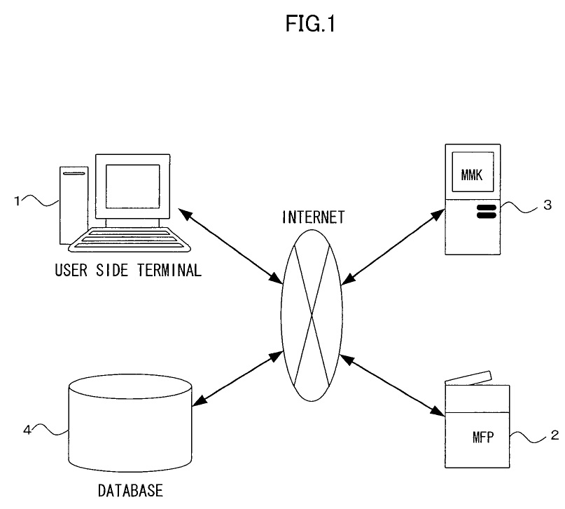

FIG. 1 is a network configuration diagram for explanation of an application example of a document management system according to the embodiment.

In a network shown in the same drawing, a user side terminal 1, an image processor (MFP: Multi Function Peripheral) 2, an MMK (Multimedia Kiosk) 3, and a database 4 are connected via electric communication lines such as the Internet in communication with one another. The user side terminal 1 is a PC possessed by a user at home or the like, for example. The MMK 3 is a multifunction terminal installed in a store such as a convenience store, which is available to general public users. Further, the image processor 2 is arranged to perform image processing such as image scan and image formation in response to a request from the user side terminal 1 or MMK3, or based on the operation to the image processor 2 by the user. The database 4 serves to store documents to be managed by the document management system according to the embodiment and various information (e.g., component elements and layout information, which will be described later) on the documents (details will be described later). Here, the storage format of data in the database 4 is a storage format as a file server or a document management database.

Here, regarding the user side terminal 1, the image processor 2, the MMK 3, and the database 4, means for connecting them in communication with one another is the Internet, however, not limited to that, LAN, WAN, or the like may be used (whether wired or wireless).

Further, in the network shown in the same drawing, in the user side terminal 1, the image processor 2, and the MMK 3, authentication processing based on information to be input by the operation input of the user and information stored in the database 4 can be performed.

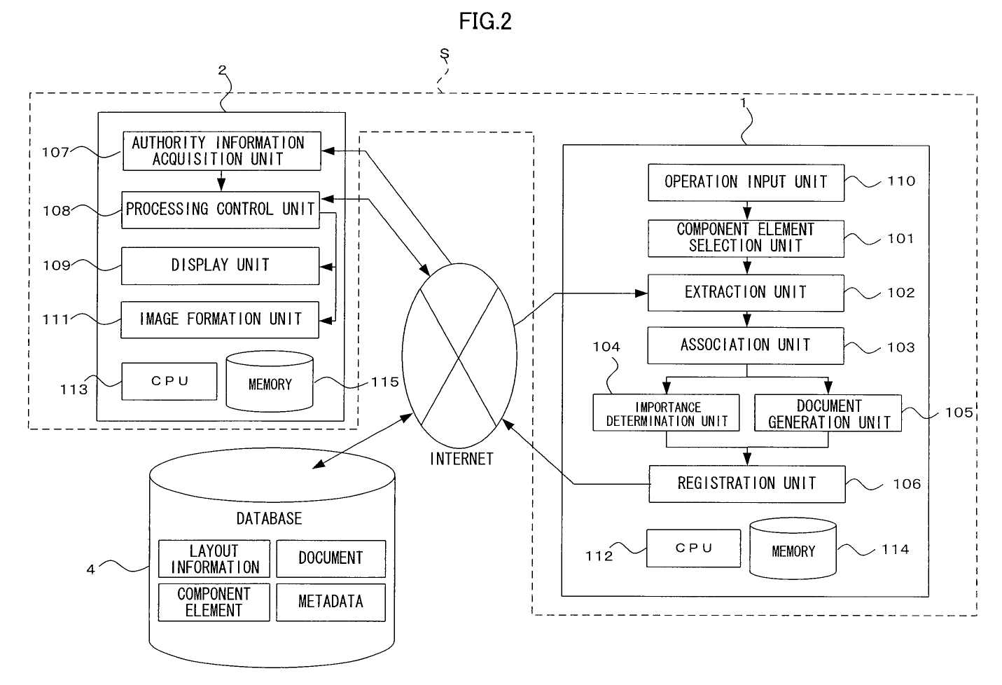

FIG. 2 is a functional block diagram for explanation of document management system S according to the embodiment.

The document management system S according to the embodiment includes a component element selection unit 101, an extraction unit 102, an association unit 103, an importance determination unit 104, a document generation unit 105, a registration unit 106, an authority information acquisition unit 107, a processing control unit 108, a display unit 109, an operation input unit 110, an image formation unit 111, a CPUs 112, 113, and MEMORYs 114, 115.

In the embodiment, the respective component parts that form the document management system are provided in one of the user side terminal 1, the image processor 2, and the MMK 3. That is, it does not matter whatever arrangement locations of respective component parts may be as long as there are all of the component parts of the document management system as a whole and communication between the respective component parts are enabled.

In the embodiment, as an example, the case where the component element selection unit 101, the extraction unit 102, the association unit 103, the importance determination unit 104, the document generation unit 105, the registration unit 106, the operation input unit 110, the CPU 112, and the MEMORY 114 are provided in the user side terminal 1, and the authority information acquisition unit 107, the processing control unit 108, the display unit 109, the image formation unit 111, the CPU 113, and the MEMORY 115 are provided in the image processor 2 is shown.

As below, details of the respective component parts of the document management system S will be described. Here, the documents to be managed in the document management system S mainly refer to “written documents”, and their formats may be either electronic or paper. Further, it is assumed that, as the respective component elements that form contents of the documents to be managed, for example, there are component elements having attributes such as “drawing”, “table”, “photograph”, “title”, “subhead”, “main body”, and “page number”.

The component element selection unit 101 selects component elements of attributes to be registered in the registration unit 101 among the above described “drawing”, “table”, “title”, “subhead”, “main body”, “page number”, etc. based on the operation input to the operation input unit 110 by the user. Thereby, the extraction processing of component elements unnecessary to be extracted from the documents by the extraction unit 102 can be omitted, and that can contribute to reduce in processing load and decrease in amounts of data stored in the database 4.

The extraction unit 102 extracts from the document the component elements selected in the component element selection unit 101 among the component elements that form document contents by acquiring the document to be managed stored in the database 4 and performing layout analysis on the document. The document with component elements to be extracted is selected in the extraction unit 102 based on the operation input to the operation input unit 110, for example.

Further, in order to perform extraction processing in the extraction unit 102, it is necessary that the document to be extracted is an electronic document. Therefore, in the case where the document with component elements to be extracted is a paper document, for example, it is converted into an electronic document in an image reader or the like (not shown) provided in MFP2, and the above extraction processing is performed on the electronic document.

Specifically, the extraction unit 102 performs layout analysis or the like on the document that is subject to extraction processing, divides the document into “component elements” and “document component information (layout information)” that is information for defining the layout of the component elements to the document and extracts them. The extraction unit 102 judges a document image from blank (space, line feed), size (font size) and positional relationship and decompose it into some areas (blocks) to extract the respective component elements. The extraction unit 102 can (1) determine the kinds of the component elements from the positions of the component elements such that the component element located at the upper left of the document is “title”, (2) acquire text information or the like by performing OCR processing on an arbitrary area of the document and determines based on the acquired information (e.g., if “2005/01/23” is acquired, the element is determined as “date information”), and (3) determine from semantic information of characters such that “1. Introduction” is “subhead” because it has a number attached at the front.

The association unit 103 associates predetermined metadata that characterize the component elements with the component elements extracted from the document in the extraction unit 102. Here, the “metadata” associated with the extracted component elements means relevant information in general relevant to the document and component elements of the document. Here, not only general “attribute information” such as “creation date and time”, “update date and time”, and “creator”, but also, for example, “operation information” and “use information” are placed as metadata. Further, in the association unit 103, also the information acquired in the extraction processing of component elements in the extraction unit 102 can be associated with component elements as metadata. Needless to add, OCR processing may be performed in the extraction unit 102, and the acquired text information itself may be associated with component elements as metadata.

The importance determination unit 104 determines importance of the component elements based on the metadata associated with the component elements in the association unit 103. Specifically, the importance determination unit 104 performs determination as to which metadata has which importance based on a predetermined rule table stored in the MEMORY 114. In the rule table here, for example, rules are defined such that, the importance of the document at more recent creation date and time is made higher than that of earlier one, the importance of the component element with which the attribute “sentence” is associated is made higher than that of the component elements with which the attribute “title” and “chart” are associated.

The document generation unit 105 arranges predetermined component elements, which have been associated with a predetermined access authority in advance, in a predetermined layout based on the component elements extracted in the extraction unit 102, and thereby, generates a document accessible only in the case based on the predetermined access authority. As a predetermined layout here, one that has been registered in advance in the database 4 as a layout that would be often used can be used, however, the layout information of the document extracted by the extraction processing in the extraction unit 102 as described above (original layout information) may be used.

The registration unit 106 registers the component elements associated in the association unit 103 and the information on metadata in the database 4. Note that the registration unit 106 may store the component element with higher importance determined in the importance determination unit 104 in a memory area in which at least one of impact resistance, stability, and security level as a memory area is high. Further, the registration unit 106 is able to not only register the component elements extracted in the extraction unit 102 or the like directly in the database 4, but also register the document generated (reconstructed) in the document generation unit 105. When the component elements are registered by the registration unit 106, setting information as to storage destination (category, folder, directory, server name, or the like) of the component elements or under which conditions (resolution, file name) the processing by the processing control unit 108 is performed, which will be described later, is also registered based on the operation input by the operation input unit 110.

The authority information acquisition unit 107 acquires authority information on an authority of a request source that requests display or printing of component elements to the processing control unit 108 from an external device such as the user side terminal 1 via the communication line such as the Internet or from an authentication device provided in the MFP2.

The processing control unit 108 allows the display unit 109 to display the component elements registered in the registration unit 106 in a predetermined layout based on the metadata associated with the component elements, or allows printing of them to a sheet in the image formation unit 111. As the predetermined layout here, the same one as the predetermined layout used in the above described document generation unit 105 can be used.

Further, the processing control unit 108 allows display or printing of the component elements associated with the metadata permitted access based on the authority information acquired in the authority information acquisition unit 107 among the component elements registered in the registration unit 106 in a predetermined layout. Additionally, in the case where the component elements registered in the registration unit 106 are to be displayed or printed in a predetermined layout (that is, the layout used in the case of display or printing has been determined in advance), the processing control unit 108 may allow selective display or printing of the only component elements that can be arranged in the predetermined layout. Further, the processing control unit 108 allows display or printing of the only component elements with which predetermined metadata such as “title”, for example, have been associated among the component elements registered in the registration unit 106 in a predetermined layout (e.g., in a layout for displaying a list of title information or the like).

The display unit 109 includes a liquid crystal display, CRT display, or the like, and has a function of displaying details of processing performed in the authentication system 1. The operation input unit 110 includes a keyboard, mouse, and the like, and has a function of receiving operation input of the user. Needless to add, the functions of the display unit 109 and the operation input unit 110 may be realized by a touch panel display or the like. Further, the image formation unit 111 serves to form an image to a sheet.

The CPUs 112, 113 serve to perform various kinds of processing in the document management system S, and also serve to realize various functions by executing programs stored in the MEMORYs 114, 115. The MEMORYs 114, 115 include ROM, RAM, and the like, for example, and serve to store various information and programs to be used in the document management system S.

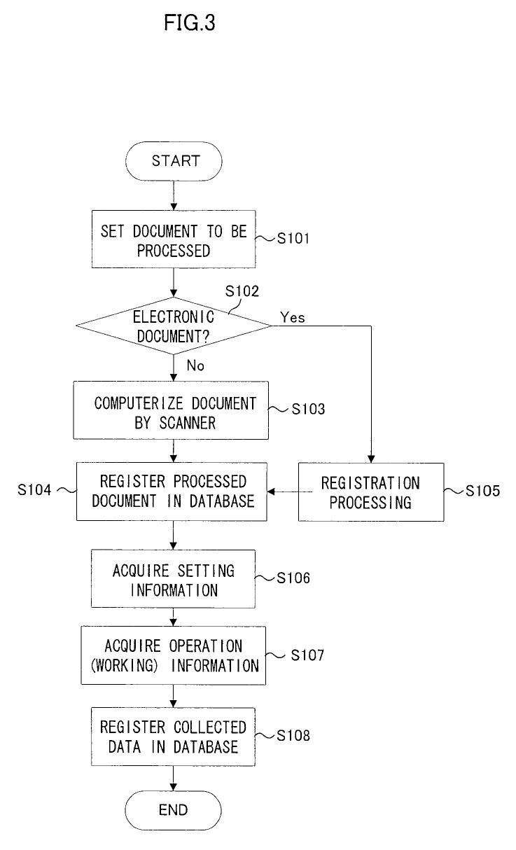

As below, details of a flow of processing (a document management method) in the document management system S having the above described configuration will be described using flowcharts of FIGS. 3, 7, 9, 12 to 14, 19, and 20.

First, in the operation input unit 110 or the like, a document that is subject to layout analysis (decomposition into component elements) is designated (S101). If the subject document is a paper document (S102, No), because computerization as preprocessing of layout analysis technology is necessary, computerization of the paper document is performed using an image reader (not shown) provided in the MFP2, for example (S103).

On the other hand, the electronic document determined as electronic data (S102, Yes) or the document computerized as described above is registered in the database 4, and a document ID is determined (S104, S105).

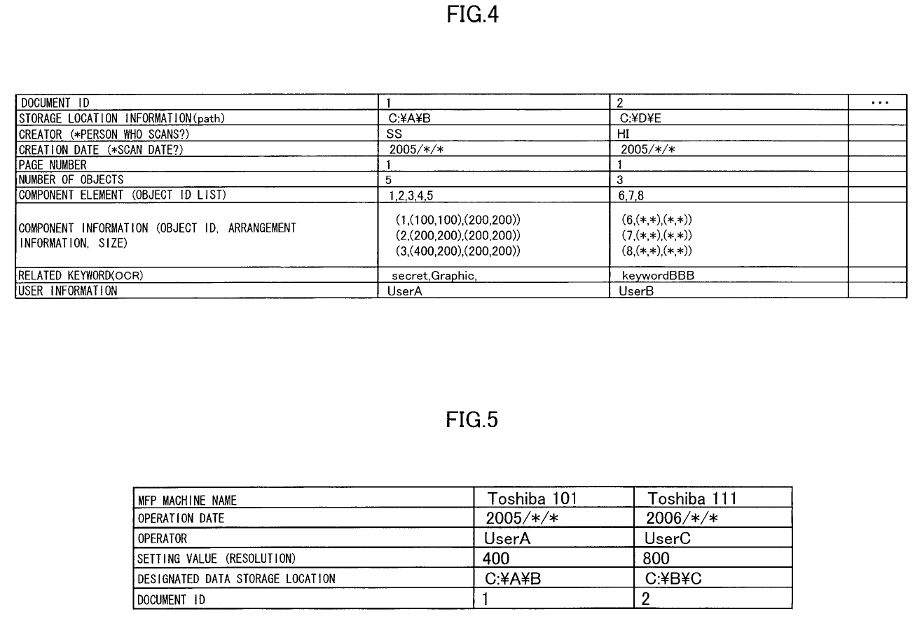

Further, the metadata on the document is added to the document information (an example of the structure is shown in FIG. 4) stored in the database 4. Further, information such as operation information in an image reader (at what time and who operates in which image reader or the like) and setting information (resolution, storage location of electronic document) is acquired from the user side terminal 1, MFP2, or the like, for example, (S106, S107), and the collected information is added to operation history information (an example of the structure is shown in FIG. 5) stored in the database 4 in association with the ID of the document and additionally written and registered in the document information (FIG. 4) at the same time (S108). Incidentally, the above described operation information such as “who” can be acquired from log-in information when the MFP2 is used or the MFP2.

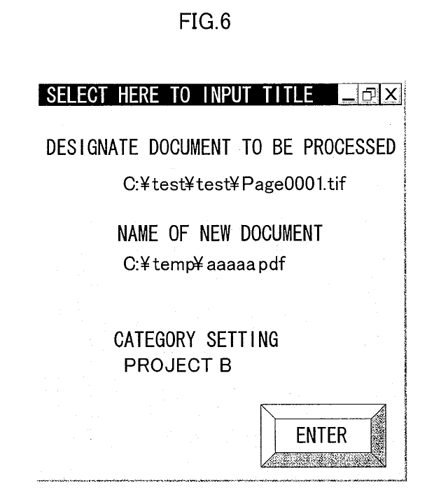

By the way, as the document that has already been computerized, for example, JPEG, PDF, and TIFF, electronic document created by word-processing software, etc. are cited. In this case, it is assumed that, using an application with a screen as in FIG. 6, for example, a document to be processed and a save destination (save name) of a new document can be designated. At the same time, the attribute information (creator, creation date, etc.) held by the electronic document is acquired, and added to the document information (FIG. 4).

Further, in the embodiment, when the user (or system) registers a document in a setting screen in the MFP2 or in the application screen as in FIG. 6, information set in consideration of use and management of documents in the future (information from which use applications and purposes are known), for example, category information, registration folder information (classification information of documents), etc. are shown, these are registered and managed in association with documents and component elements in the database 4.

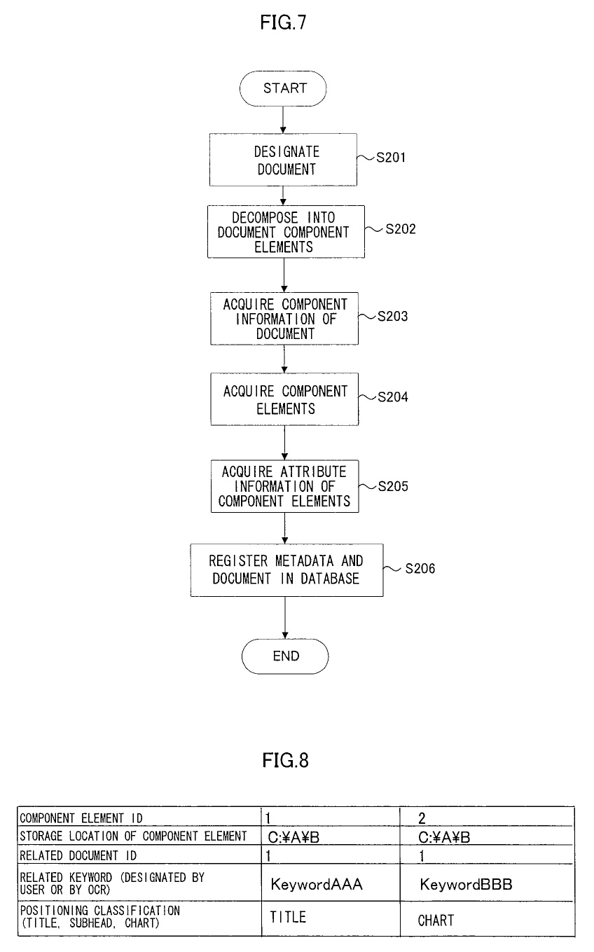

Subsequently, as shown in the flowchart of FIG. 7, a document with component elements to be extracted is designated among the documents registered in the database 4 in the operation input unit 110 (S201), the extraction unit 102 decomposes the contents of the subject document into the respective component elements (S202) and extracts component information (layout information) of the document (extraction step). Thus extracted objects are registered in the database 4.

Here, at the extraction step, component elements having attributes to be registered in the registration step selected in the component element selection unit 101 (component element selection step) are extracted based on the operation input of the user.

When the document is divided into component elements and the component information is extracted by the extraction unit 102 (S203, S204), unique information (ID) and metadata related thereto are associated with respect to each component element (association step), and these associated information on the component elements and metadata are registered in a metadata table stored in the database 4 (registration step).

As the metadata to be registered, in the case where classification names (title, subhead, chart, main body, etc.) corresponding to positioning of the component elements within the document can be acquired by the layout analysis technology (S205), information other than the storage locations of component elements (because sometimes plural fileservers and DBs exist within the database 4), document ID of cut out source, data capacity of component elements, size, creation date of component elements, creation module (the name of layout analysis technology) etc. that can be acquired at the time of layout analysis (from the system), for example, the names are registered as metadata in the database 4 (S206). An example of the structure of the component element information is shown in FIG. 8.

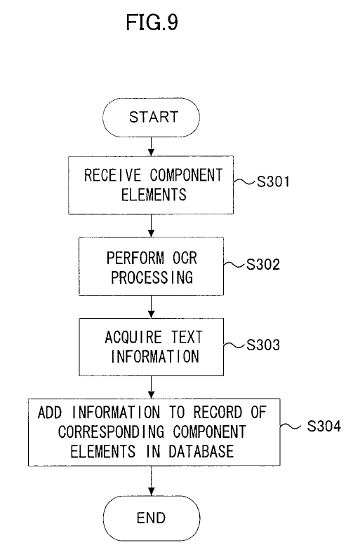

Further, as shown in the flowchart of FIG. 9, the component elements acquired as described above (S301) may be converted using an OCR technology or the like (S302) from image data into character data (S303), and registered as metadata items to which the component element table stored in the database 4 corresponds (S304).

Further, at the same time of the creation of the component element table, metadata of a document acquired by the extraction unit 102 such as information representing how many component elements are contained in the document, a component element list of the document (ID list), component information of the document (where the respective component elements are located in the document), dates of additional information, text information acquired when OCR processing is performed are added to the record of the document of the metadata document table.

The above described component element table enables reconstruction of the document and use of the document by using these registered component information and component elements and information within the component element table of the document without referring to the original data of the document.

In the database 4, “document information (FIG. 4)”, “component element information (FIG. 8)”, and “operation history information (FIG. 5)”, etc. are managed as described above, however, these information are not necessarily managed in one recording area within the database 4, but they may be managed by different applications within the database 4 or distributed and managed by storing them in different storage devices according to use application, purpose, and security authority.

As criteria for distributing and managing these information, for example, classification according to types of category, kinds of folders, processing executants, types of component elements (charts only, titles only, or the like) of documents at the time of registration, or kinds of devices of image reader (kinds of scanners, kinds of applications), kinds of storage locations of image reader (by domains, by floors, . . . ), etc. are cited.

Further, in the importance determination unit 104, the importance of the component elements may be determined (importance determination step) based on the metadata associated with the component elements in the association step, and, in the registration unit 106, as the component element has the higher importance determined at the importance determination step, it may be stored in a memory area at a higher security level.

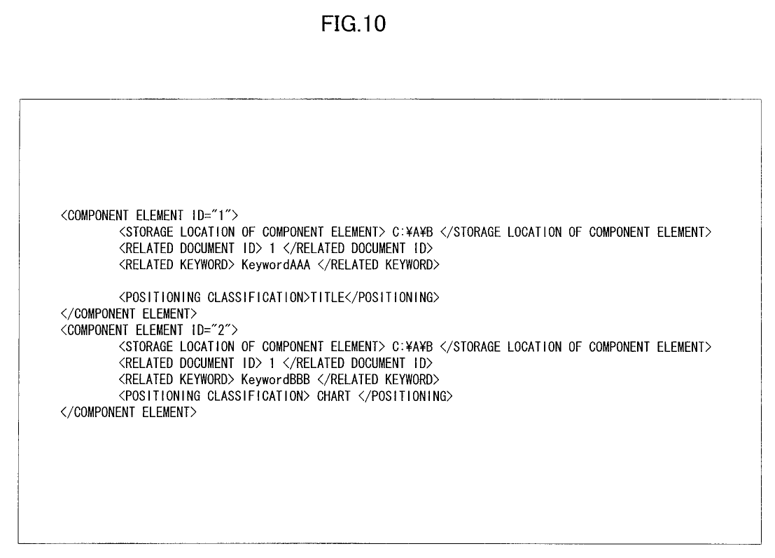

Further, the information of the document table, the component element table, and the operation history table may be stored in a memory area different from the memory area in which the document and document component elements are stored, however, they can be embedded as metadata within the document and the component elements of the document and held. Specifically, in the case where metadata is embedded within a document file, the data is stored in an appropriate format in an area in which metadata can be registered within the document file (FIG. 10).

By the way, in the case where a user attempts to use the document component elements registered in the database 4 as described above, the information may be presented with use restriction of the information based on the metadata associated with the document.

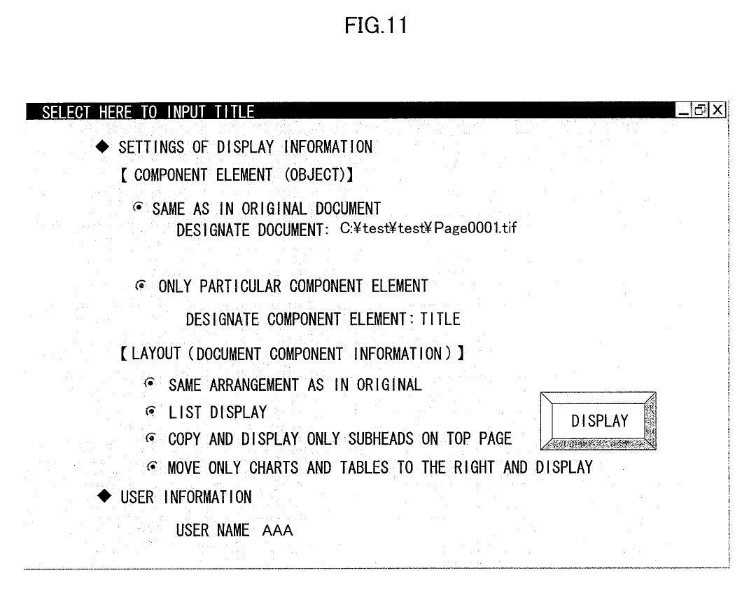

The user makes a request for display or printing of the document by the items displayed on the display unit 109. In this regard, a document display application as shown in FIG. 11 may be used, or a mechanism of linking to the database 4 when an icon at the desktop is clicked may be used.

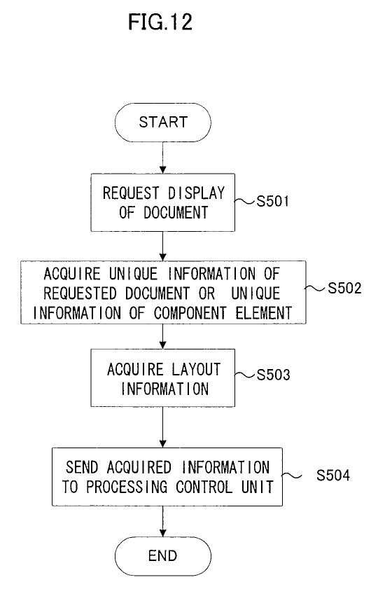

In either case, what is necessary here is to acquire information from which, which document the user or system requests is known in the processing control unit 108. The information acquired by the processing control unit 108 is (unique) information from which the document can be determined, for example, title, ID, full path information, etc. (S501 to S503). The processing control unit 108 performs screen display of the corresponding document or the like based on thus acquired information (see FIG. 12).

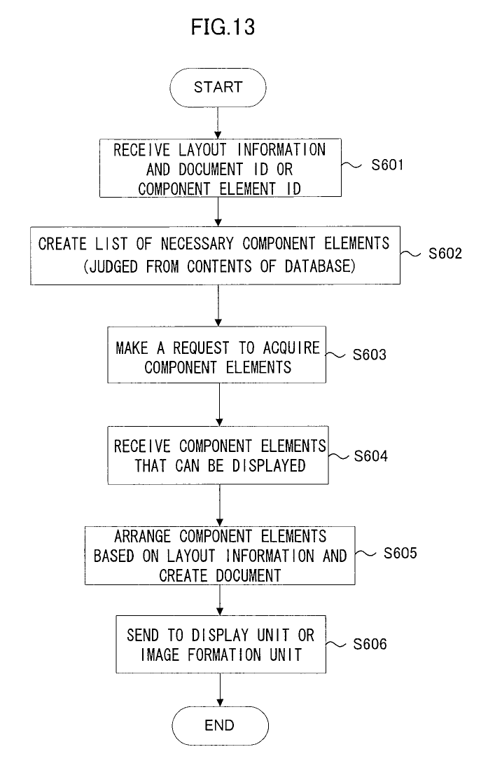

As shown in FIG. 13, when display execution is commanded (S601), the processing control unit 108 acquires, from the requested document information (title, ID, full path information, or the like), information as to what kinds of information (layout information, information on component elements, or the like) is necessary to construct the document from the database 4 (S602).

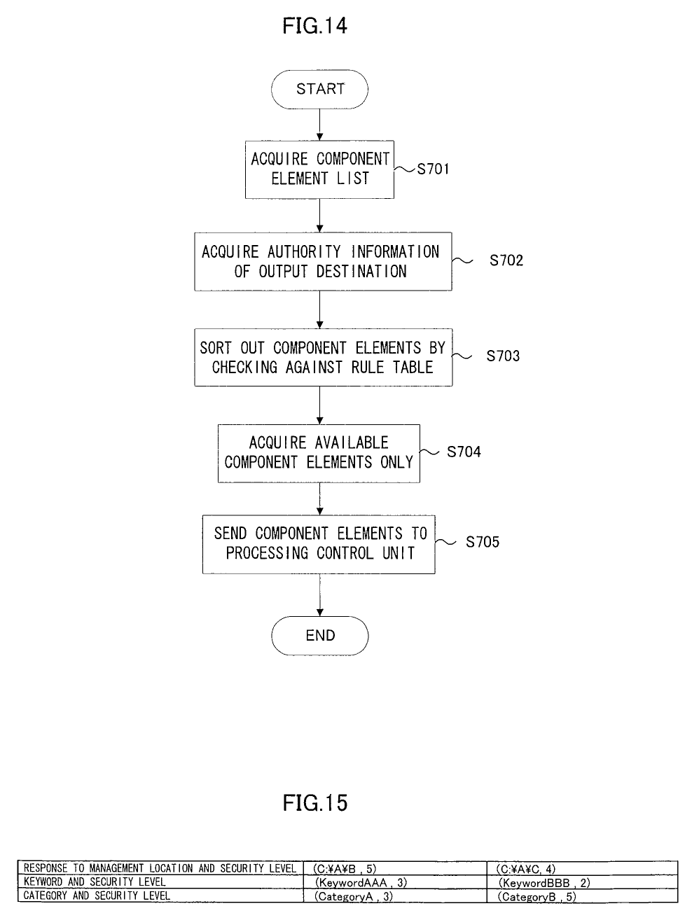

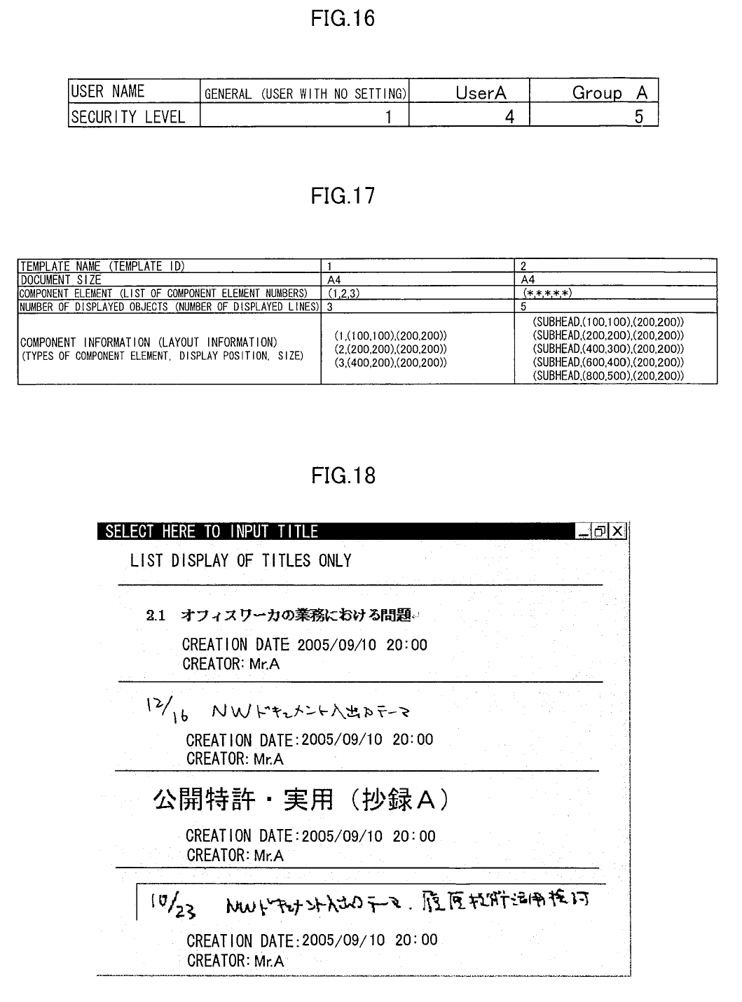

The processing control unit 108 performs acquisition of component elements necessary for forming the requested document (component elements, metadata of component elements, metadata of the document) (S603, S604). In this regard, in the processing control unit 108, as shown in FIG. 14, the acquired component elements are judged according to the authority of the request source (S701, S702), and whether they are provided in the layout of the document or not is determined. The judgment criteria in this case are that information of the user who has made the request and environment information (where and who attempts to view) of the display unit 109 are acquired, determination rules (an example of the structure is shown in FIG. 15) are determined based on the information and whether they can be presented or not is determined according to the security settings (an example of the structure is shown in FIG. 16) of the user (S703), and only the component elements that can be presented are sent to the processing control unit 108 (S704, S705).

The processing control unit 108 receives the component elements and metadata and performs reconstruction of the document based on the component information (or original layout information) of the document (S605). The reconstructed document can be displayed on the display unit 109, or sent to the image formation unit 111 and output as a paper document (S606).

Thus, when the processing control unit 108 allows the component elements registered at the registration step to be displayed or printed in a predetermined layout, the unit selectively allows only the component elements that can be arranged in the predetermined layout to be displayed or printed based on the metadata associated with the component elements (processing control step).

Further, in the authority information acquisition unit 107, authority information on the authority of the request source that requests display or printing of the component elements to the processing control step can be acquired (authority information acquisition step), and the processing control unit 108 is able to allow display or printing of the component elements associated with the metadata permitted access based on the authority information acquired in the authority information acquisition step among the component elements registered in the registration step in the predetermined layout. In the positions of the component elements that can not be displayed because of use authority, for example, characters or images stating “no display authority” are allowed to be displayed on the display unit.

The document reconstructed as described above can be registered as a new electronic document in the database 4, and, in this case, a record is added as a new document to the database 4.

Further, at the time of construction of document in the processing control unit 108, a document may be constructed by arranging particular component elements in a designated layout using a predetermined layout template.

For example, when a template (in which how and what kinds of component elements are arranged are defined) is designated by the document display application as in FIG. 11, the details (which template is used and which component elements are requested) are sent to the processing control unit 108 in the display unit.

In the processing control unit 108, information of layout structure of the document in the selected template is acquired from template information (an example of structure is shown in FIG. 17). The processing control unit 108 requests corresponding component elements based on the structure information of the template information.

In the processing control unit 108, acquisition of corresponding information (component elements, metadata of component elements, metadata of the document) from the database 4 is performed according to the determination rule (FIG. 15).

The processing control unit 108 acquires component elements and metadata and creates a group of component elements (performs new document construction) according to the component information of the document. The created document can be displayed on the display unit 109, or output as a paper document in the image formation unit 111. For example, if the template that displays only the document titles is selected, the document as in FIG. 18 is constructed. Needless to add, thus constructed document can be registered as a new electronic document. In the display screen as shown in FIG. 18, when a particular component element is selected by the operation input unit 110, the original document of the component element stored in the database 4 is linked (activated, displayed, and printed).

As kinds of templates that determine layouts and display objects, one that holds layout information of the original document, one desired to display only particular kinds of component elements, one that changes the layout of the original document such as a method of moving and arranging particular kinds of component elements (e.g., the chart part is located at the lower part of the document, and the header part is located at the upper part of the document and copied and located on the top page), one that collects and lists the component elements having the same attribute only in different documents, and one that displays only the component elements for which the same access authority has been set (at the security level) are cited.

That is, in the template information table, in which layout what kinds of component elements (whether it is of a particular document ID or not, the type of component element, security level) are arranged is defined. In addition, complex refinement such that only the title parts are displayed in the documents that someone has been created can be performed.

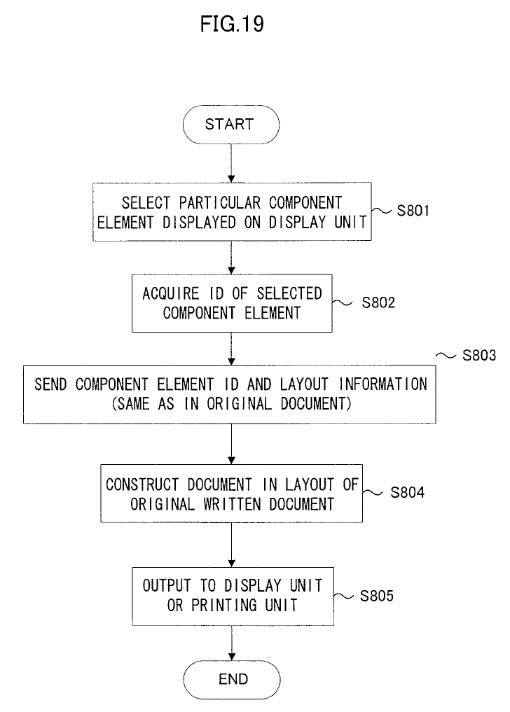

Further, as shown in the flowchart of FIG. 19, when the document newly constructed by combining component elements is displayed on the display unit 109, if the user selects a particular component element within the document (S801), the processing control unit 108 acquires information on the selected component element (component element ID or the like) and reconstructs the document in the layout of the original document based on the component element ID and layout information (S802 to S804). Subsequently, it is output to the display unit 109 or the image formation unit 111 (S805), or saved as a new document.

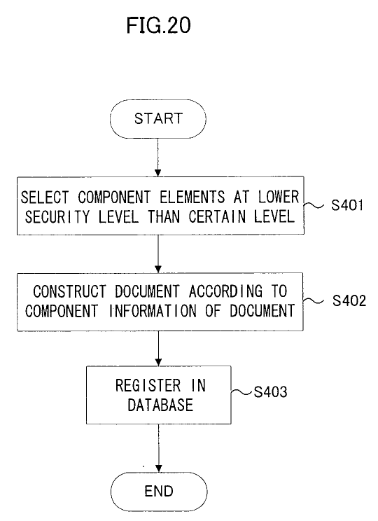

In addition, as shown in the flowchart of FIG. 20, the construction of the document for which use restriction of component elements has been performed is performed in advance according to the disclosure use application and purpose of the document, and it may be held in the database 4.

That is, the operation that a document is constructed by performing restriction (e.g., a document from which a chart part has been removed or with a chart part only, contrary) based on the kind of component element, or a document is constructed by removing component element at a high security level (a component element containing a keyword undesirable to be disclosed, a component element at a high confidential level, a predetermined component element associated with a predetermined access authority in advance) (a document accessible only in the case based on a predetermined access authority) is performed (S401, S402).

The registration unit 106 creates documents in advance as described above according to use applications and purposes and registers them in the database 4 (registration step) (S403).

For example, in the case where accessible file servers vary by post, document creation of original written documents is performed according to the respective authorities and the respective documents are registered in the file servers. In the case where the disclosure use application or disclosure purpose is clear, what is necessary is that there is an application that can display a document in the display unit because documents have been created in advance, and the document can be promptly displayed. Thereby, there is no need to provide a special application at the device side for image display of documents, and the effect that processing load can be reduced is realized.

The respective steps in the processing in the above described document management system are realized by executing document management programs stored in the MEMORYs 114, 115 by the CPUs 112, 113.

The case where functions of implementing the invention have been recorded within the apparatus in advance has been described in the embodiment, however, not limited to that, the same functions may be downloaded from a network to the apparatus, or a recording medium in which the same functions have been stored may be installed in the apparatus. The form of the recording medium may be any form as long as it can store programs and can be read by the apparatus such as a CD-ROM. Further, the functions obtained by the install or download in advance as described above may cooperate with an OS (operating system) within the apparatus or the like to realize the functions.

As described above, according to the embodiment, metadata according to use applications and purposes may be provided to component elements and they may be distributed and managed according to the kinds of metadata depending on circumstances. Further, in response to the information (document) request from the user or system, display restriction and use restriction can be performed by judging whether they can be presented or not is judged from the metadata of the component elements and creating or reconstructing a document by combining only the component elements that can be presented.

The invention has been described in detail according to a specific aspect, however, it will be obvious to those skilled in the art that various changes and modifications may be made unless they depart from the scope of the invention.

As described above in detail, according to the invention, since the management in units of component elements of contents of documents to be managed can be performed, a technology that can contribute to improvement in convenience in the document management can be provided.

It is claimed:

1. A document management system comprising:
an extraction unit that extracts component elements forming contents of a document to be managed from the document;
an association unit that associates predetermined metadata characterizing the component elements with the component elements extracted in the extraction unit; and
a registration unit that registers information on the component elements and metadata associated in the association unit.

2. The document management system according to claim 1, wherein the extraction unit extracts the component elements forming the contents of the document by performing layout analysis on the document.

3. The document management system according to claim 1, having an importance determination unit that determines importance of the component elements based on the metadata associated with the component elements in the association unit,
wherein the registration unit stores the component elements with higher importance determined in the importance determination unit in memory areas at higher security levels.

4. The document management system according to claim 1, having a component element selection unit that selects component elements having attributes to be registered in the registration unit based on operation input by a user,
wherein the extraction unit extracts the component elements selected in the component element selection unit.

5. The document management system according to claim 1, having a document generation unit that arranges predetermined component elements associated with a predetermined access authority in a predetermined layout based on the component element extracted in the extraction unit so as to generate a document accessible only in the case based on a predetermined access authority,
wherein the registration unit registers the document generated in the document generation unit.

6. The document management system according to claim 1, having a processing control unit that allows the component elements registered in the registration unit to be displayed or printed in a predetermined layout based on the metadata associated with the component elements.

7. The document management system according to claim 1, having an authority information acquisition unit that acquires authority information on an authority of a request source that requests display or printing of the component elements to the processing control unit,
wherein the processing control unit allows the component elements associated with metadata permitted access based on the authority information acquired in the authority information acquisition unit among the component elements registered in the registration unit to be displayed or printed in a predetermined layout.

8. The document management system according to claim 1, wherein, when attempting to allow the component elements registered in the registration unit to be displayed or printed in a predetermined layout, the processing control unit selectively allows only component elements that can arranged in the predetermined layout to be displayed or printed.

9. The document management system according to claim 1, wherein the processing control unit allows only component elements associated with predetermined metadata among the component elements registered in the registration unit to be displayed or printed in a predetermined layout.

10. A document management method comprising:
an extraction step that extracts component elements forming contents of a document to be managed from the document;
an association step that associates predetermined metadata characterizing the component elements with the component elements extracted in the extraction step; and
a registration step that registers information on the component elements and metadata associated in the association step.

11. The document management method according to claim 10, having a processing control step that allows the component elements registered in the registration step to be displayed or printed in a predetermined layout based on the metadata associated with the component elements.

12. A document management program allowing a computer to execute:
an extraction step that extracts component elements forming contents of a document to be managed from the document;
an association step that associates predetermined metadata characterizing the component elements with the component elements extracted in the extraction step; and
a registration step that registers information on the component elements and metadata associated in the association step.

13. The document management program according to claim 12, wherein the extraction step extracts the component elements forming the contents of the document by performing layout analysis on the document.

14. The document management program according to claim 12, having an importance determination step that determines importance of the component elements based on the metadata associated with the component elements in the association step,
wherein the registration step stores the component elements with higher importance determined in the importance determination step in memory areas at higher security levels.

15. The document management program according to claim 12, having a component element selection step that selects component elements having attributes to be registered in the registration step based on operation input by a user,
wherein the extraction step extracts the component elements selected in the component element selection step.

16. The document management program according to claim 12, having a document generation step that arranges predetermined component elements associated in advance with a predetermined access authority in a predetermined layout based on the component element extracted in the extraction step so as to generate a document accessible only in the case based on a predetermined access authority,
wherein the registration step registers the document generated in the document generation step.

17. The document management program according to claim 12, having a processing control step that allows the component elements registered in the registration step to be displayed or printed in a predetermined layout based on the metadata associated with the component elements.

18. The document management program according to claim 12, having an authority information acquisition step that acquires authority information on an authority of a request source that requests display or printing of the component elements to the processing control step,
wherein the processing control step allows the component elements associated with metadata permitted access based on the authority information acquired in the authority information acquisition step among the component elements registered in the registration step to be displayed or printed in a predetermined layout.

19. The document management program according to claim 12, wherein, when attempting to allow the component elements registered in the registration step to be displayed or printed in a predetermined layout, the processing control step selectively allows only component elements that can be arranged in the predetermined layout to be displayed or printed.

20. The document management program according to claim 12, wherein the processing control step allows only component elements associated with predetermined metadata among the component elements registered in the registration step to be displayed or printed in a predetermined layout.
